(19) United States
(12) Patent Application Publication
(10) Pub. No.: US 2018/0088775 A1
(43) Pub. Date: Mar. 29, 2018

(54) METHOD OF CONTROLLING MOBILE DEVICE WITH TOUCH-SENSITIVE DISPLAY AND MOTION SENSOR, AND MOBILE DEVICE

(71) Applicant: CM HK Limited, Fortress Hill (HK)

(72) Inventors: Zhou Ye, Foster City, CA (US); Shun-Nan Liou, Taipei (TW); Ying-Ko Lu, Taoyuan County (TW)

(21) Appl. No.: 15/715,242

(22) Filed: Sep. 26, 2017

Related U.S. Application Data
(63) Continuation of application No. 13/492,918, filed on Jun. 10, 2012, now abandoned.
Application No. 13/492,918 is a continuation-in-part of application No. 12/967,401, filed on Dec. 14, 2010, now Pat. No. 9,564,075.
(60) Provisional application No. 61/291,117, filed on Dec. 30, 2009.

(51) Int. Cl. G06F 3/0481; G06F 3/0488; G06F 3/01; G06F 3/0346

(52) U.S. Cl. CPC G06F 3/04815; G06F 3/0488; G06F 2203/04806; G06F 3/0346; G06F 3/017

(57) ABSTRACT

Systems and methods for controlling a display are provided, of which an example system includes: an electronic device having a motion sensor module configured to provide a sensed motion value, the motion sensor module having an accelerometer, a gyroscope, and a magnetometer; at least one processor configured to: estimate motion of the device to provide an estimated yaw and an estimated pitch, respectively, based on angular velocity sensed by the gyroscope; determine a control movement user input of the device if: a sum of the acceleration value on each axis corresponds to a force threshold; and both the estimated yaw and the estimated pitch do not correspond to a rotation threshold; determine a control rotation user input of the device based on a difference between magnetic parameters, including measured magnetic field values, and angular speed parameters, including estimated magnetic field values estimated based on angular speed values; adjust information based on at least one of the control movement or the control rotation; and provide media content configured to display based on the adjusted information.

### CROSS-REFERENCE TO RELATED APPLICATIONS

This application is a continuation application, which claims the benefit of and priority to U.S. application Ser. No. 13/492,918, filed on Jun. 10, 2012, which is a continuation-in-part application of application Ser. No. 12/967,401, filed on Dec. 14, 2010, now patented as U.S. Pat. No. 9,564,075, issued Feb. 7, 2017, which claims the priority benefit of provisional application Ser. No. 61/291117 filed on Dec. 30, 2009, now expired. The entirety of each of the above-mentioned patent applications is hereby incorporated by reference herein and made a part of this specification.

### BACKGROUND OF THE INVENTION

### 1. Field of the Invention

The invention relates to mobile device, in particular, the invention relates to controlling a mobile device configured with a touch-sensitive display and a motion sensor.

### 2. Description of Related Art

Nowadays, more and more mobile electronic device have been widely used in our daily life. These mobile electronic devices are provided with some proper operation interfaces, such as buttons and keypads. Though operating the 20 operation interfaces, users can control the mobile electronic devices to execute more and more function.

In addition to the abovementioned operation interfaces, touch screens are widely used to serve as a new kind of operation interfaces since they may be implemented external to the mobile electronic device such that the overall thickness of the mobile electronic device may be reduced. Touch screen also offers the freedom to user's operations based on user's intuitional control behavior, creating a user feel friendly and easy-operating environment.

Especially, for the new generation smart mobile electronic devices, such as the smart mobile devices, the smart PDA, smart portable electronic GPS device, etc., the feeling of friendly and easy-operating can be very important to the users while the users may operate such new generation smart portable electronic devices under various operation conditions.

In view of the above, there are still many inconvenient operations associated with such new generation smart mobile electronic devices due to the limitation that almost all of the operations require user's actual and direct touch or pressing actions on the touch screens, which introduces certain degree of unfriendliness and limitations to the users and the operations thereof. For example, considering the function of zoom in/out of a portable electronic device, one must operate the device and the touch screen implemented thereon with fingers to zoom in/out certain display field by swing two fingers on the touch screen.

Moreover, taking the function of displaying front/next image or a first/last image for example, when the users intends to operate the smart mobile device to display a front/next image or a first/last image from a plurality of images, it is unavoidable for the user to search for the function icons displayed on the touch screens, and then press the positions of the function icons displayed on the touch screen.

Nevertheless, taking the function of field-moving for example, when the users intends to operate the smart mobile device to display a 360-degree full view image with an overall filed greater than the display field that the smart mobile device can display, it is also unavoidable for the user to search for the function icons displayed on the touch screens, and then keep in pressing the positions of the function icons displayed on the touch screen to move the display field.

Accordingly, there is a need for more efficient, user-friendly methods for controlling such mobile devices, touch screens, and/or applications.

### SUMMARY OF THE INVENTION

In view of the shortcomings of the prior arts, there are inconvenient operations associated with portable electronic devices including such as smart phones since almost current operations requires actual or physical touches on a display or touch screens integrated therein. Such limitation requiring direct or physical touches on the display, for example touch screens, may hinder user's interactions in some particular situations such as gaming or media playing and viewing and may too reduce user friendliness of use of the device. One of the objectives of the present invention is to provide an electronic control apparatus to be integrated with or in a portable electronic device including for example smart phone or tablet. Another objective is to provide a control method to responsively control a display or media content on a display of the portable electronic device integrated with the control apparatus comprising a motion sensor module capable of detecting and generating motion sensor signals in response to rotations and/or movements of the portable electronic device and such that the display or media content displayed on the portable electronic device may be displaced or altered in such a predetermined manner responding to the motion sensor signals of the motion sensor module of the control apparatus integrated in the portable electronic device subject to rotations and/or movements. In other words, the electronic control apparatus may comprise a sensing module or a motion sensor module to sense the rotations and/or movements of the portable electronic in order to responsively control the display of the portable electronic device.

According to one embodiment of the present invention, the electronic control apparatus may be integrated or embedded in a portable electronic device for responsively controlling a display of the portable electronic device, in particular media content on a display field of the display of the portable electronic device. The electronic control apparatus may include a sensing module or a motion sensor module for detecting and generating motion sensor signals and a processing unit for calculating and processing said motion sensor signals. The sensing module is configured to sense a first rotation angle of the portable electronic device and to responsively send out a first rotation sensing signal when the portable electronic device is subject to rotations detected by a first rotation means. The processing unit is electrically connected to the sensing module, preset with a first threshold angle, and embedded with an algorithm means for receiving the first rotation sensing signal to calculate whether the first rotation angle is greater than the first threshold angle, When the first rotation angle is greater than the first threshold angle, the processing unit sends out a zoom in/out signal to control the display to zoom in/out the display field.

A responsive control method is carried out by the electronic control apparatus comprising steps of: presetting a first threshold angle; sensing an first rotation angle of the portable electronic device to accordingly send out a first rotation sensing signal when the portable electronic device is rotated by a first rotation means; receiving the first rotation sensing signal to calculate whether the first rotation angle is greater than the first threshold angle; and sending out a zoom in/out signal to control the display to zoom in/out the display field when the first rotation angle is greater than the first threshold angle.

Preferably, when the display is operated to display a plurality of images, the sensing module further can sense an acceleration value of the portable electronic device to accordingly send out an acceleration sensing signal when the portable electronic device is rotated by a second rotation means. The processing unit can be preset with a first threshold acceleration value, receive the acceleration sensing signal to calculate whether the acceleration value is greater than the first threshold acceleration value, and send out a first page-switch signal to control the display to display a front/next image of the image when the acceleration value is greater than the first threshold acceleration value.

Moreover, the processing unit further can be preset with a second threshold acceleration value greater than the first threshold acceleration value, receive the acceleration sensing signal to calculate whether the acceleration value is greater than the second threshold acceleration value, and send out a second page-switch signal to control the display to display a first/last image of the images when the acceleration value is greater than the second threshold acceleration value.

More preferably, when the display is operated to display a full view image with an overall filed greater than the display field, the sensing module further can sense a second. rotation angle of the portable electronic device to accordingly send out an second rotation sensing signal when the portable electronic device is rotated by a third rotation means. The processing unit can be preset with a second threshold angle, receive the second rotation sensing signal to calculate whether the second rotation angle is greater than the second threshold angle, and send out a field-moving signal to control the display to move the display field within the overall field of the full view image when the second rotation angle is greater than the second threshold angle.

It is suggested that the portable electronic device can be a portable electronic phone, a portable electronic PDA or other portable electronic device. It is further suggested that abovementioned first rotation means can be to vertically roll the portable electronic device forwardly or backwardly to generate the first rotation angle; abovementioned second rotation means can be to vertically tilt the portable electronic device along a counterclockwise direction or a clockwise direction to generate the acceleration value; and abovementioned third rotation means can be to horizontally rotate the portable electronic device along a counterclockwise direction or a clockwise direction to generate the second rotation angle.

Comparing with the portable electronic device, such as smart portable electronic phone, as disclosed in prior arts, in the present invention, the sensing module can sense the motion conditions, such as the first rotation angle, the acceleration value, and the second rotation value, of the portable electronic device, to respectively carry out the specified hot functions, such as zoom in/out, switching to a front/next/first/last image, and field-moving. Therefore, it is obvious that through the present invention, the user can operate the portable electronic device to execute the specified hot functions by rotating the portable electronic phone by the specified rotating means, such as the first rotation means, the second rotation means, and the third rotation means as suggested above, so as to make the user feel more friendly and convenient when they operate the portable electronic device.

In an embodiment, a method of controlling a mobile device configured with a touch-sensitive display and a motion sensor is provided. The method of controlling the mobile device includes the following: detecting a contact with the touch-sensitive display while the mobile device is in a first state to determine whether the detected contact corresponds to a predefined icon; detecting a rotation or a movement with the motion sensor while the mobile device is in the first state to determine whether the detected rotation or movement corresponds to a predefined gesture; and transitioning the mobile device to a second state when the detected contact corresponds to the predefined icon, and the detected rotation or movement corresponds to the predefined gesture.

The first state is a user-interface lock state and the second state is a predefined state. The predefined state is a user-interface unlock state.

The method of controlling a mobile device configured with a touch-sensitive display and a motion sensor further comprises the following: maintaining the mobile device in the first state when the detected contact does not correspond to the predefined icon, or the detected rotation or movement does not correspond to the predefined gesture.

The method of controlling a mobile device configured with a touch-sensitive display and a motion sensor further comprises the following: while the mobile device is in the first state, preventing the mobile device from performing a predefined set of actions in response to detecting any contact with the touch-sensitive display that does not correspond to the predefined icon or in response to detecting any rotation or movement with the motion sensor that does not correspond to the predefined gesture.

The movement detected by the motion sensor is a horizontal movement or the rotation detected by the motion sensor is a vertical rotation. The motion sensor includes at least one of a gravity sensor, a gyroscope or a magnetometer.

Another method of controlling a mobile device configured with a touch-sensitive display and a motion sensor is provided. This method includes the following: detecting contact with the touch-sensitive display; selecting a widget in a starting page and dragging the widget when the contact starts corresponding to the widget; detecting a rotation or movement with the motion sensor; transitioning the mobile device from the starting page to a destination page according to the detected rotation or the movement of the mobile device of the mobile device; and moving the widget from the starting page to the destination page when the contact terminates in the destination page.

In addition, the widget is moved from the starting page to the destination page when the contact terminates in the destination page by moving the widget from the starting page to the destination page when the continuous contact is maintained between the time the contact starts corresponding to the widget and the time the contact terminates in the destination page.

The another method of controlling a mobile device configured with a touch-sensitive display and a motion sensor further comprises of maintaining the widget in the starting page when the contact does not terminate in the destination page. The mobile device includes at least one of a pad, a mobile phone and a notebook.

The mobile device is provided. The mobile device comprises a touch-sensitive display, a motion sensor, a memory, one or more processors, and one or more modules stored in the memory and configured for execution by the one or more processors. The one or more modules include instructions for performing the following: detecting contact with the touch-sensitive display while the mobile device is in a first state; detecting rotation or movement with the motion sensor while the mobile device is in the first state; and transitioning the mobile device to a second state according to the detected contact and the detected rotation or movement.

A computer program product for use in conjunction with a mobile device comprising a touch-sensitive display is provided. The computer program product comprises a computer readable storage medium and an executable computer program mechanism embedded therein. The executable computer program mechanism comprises instructions for performing the following: detecting contact with the touch-sensitive display while the mobile device is in a first state; detecting rotation or movement with the motion sensor while the mobile device is in the first state; and transitioning the mobile device to a second state according to the detected contact and the detected rotation or movement.

The devices, characteristics, and the preferred embodiments of this invention are described with relative figures as follows.

### BRIEF DESCRIPTION OF THE DRAWINGS

FIG. 1 is a functional diagram illustrating a control apparatus being embedded into a portable electronic device in accordance with a preferred embodiment of the present invention.

FIG. 2 is a perspective illustrative view of the control apparatus and the portable electronic device in accordance with the preferred embodiment of the present invention.

FIG. 3A to 3C illustrate the control method for zooming in/out the display field of the display of the portable electronic device in accordance with the preferred embodiment of the present invention.

FIG. 4A to 4C illustrate the control method for switching to a front/next image in accordance with the preferred embodiment of the present invention.

FIG. 5A to 5C illustrate the control method for switching to a first/last image in accordance with the preferred embodiment of the present invention.

FIG. 6A to 6C illustrate the control method for moving display field when displaying a full view image in accordance with the preferred embodiment of the present invention.

FIG. 7A to FIG. 7C illustrate a simplified flowchart of the control method for zooming in/out the display field, switching to a front/next image, switching to a first/last image, and moving display field.

FIG. 8 shows a flow chart of a method of controlling a mobile device configured with a motion sensor according to a first embodiment of the present invention.

FIG. 9 shows a flow chart of a method of controlling the mobile device configured with a motion sensor according to a second embodiment of the present invention.

FIG. 10 shows a flow chart of a method of controlling the mobile device configured with a motion sensor according to a third embodiment of the present invention.

FIG. 11 shows a flow chart of a method of controlling the mobile device configured with a motion sensor according to a fourth embodiment of the present invention.

FIG. 12 shows a flow chart of a method of controlling a mobile device configured with a motion sensor according to a fifth embodiment of the present invention.

FIG. 13 shows a flow chart of a method of exploring the 360 degree panoramic street view in the horizontal plane with a motion sensor which includes the gyroscope and the magnetometer according to the embodiment of the present invention.

FIG. 14 shows a block diagram of a mobile device according to the embodiment of the present invention.

FIG. 15 shows an operation of the mobile device according to the embodiment of the present invention.

FIG. 16 shows a flow chart of a method of controlling a mobile device configured with a touch-sensitive display and a motion sensor according to the embodiment of the present invention.

FIG. 17 shows another operation of the mobile device according to the embodiment of the present invention.

FIG. 18 shows a flow chart of another method of controlling a mobile device configured with a touch-sensitive display and a motion sensor according to the embodiment of the present invention.

FIG. 19 shows yet another operation of the mobile device according to the embodiment of the present invention.

FIG. 20 shows another operation of the mobile device according to the embodiment of the present invention.

### DETAILED DESCRIPTION OF PREFERRED EMBODIMENTS

The control apparatus and the control method as provided in accordance with the present invention can be widely adapted to control various types of portable or portable electronic devices. The following content recites different embodiments of the present invention and is for illustrative purposes only to describe principles and technical features as well as technique effects achievable by various embodiments of the present invention.

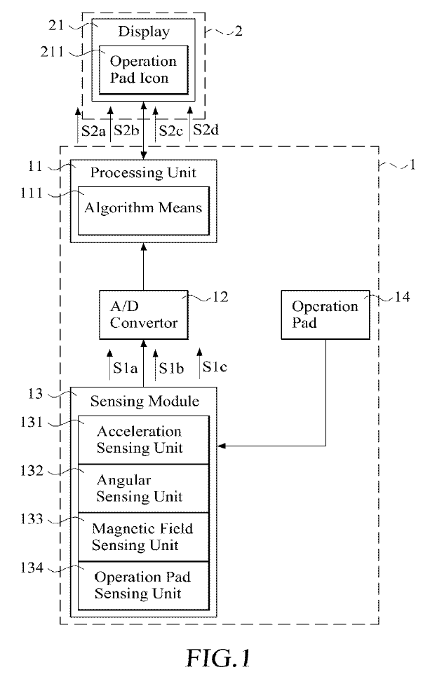

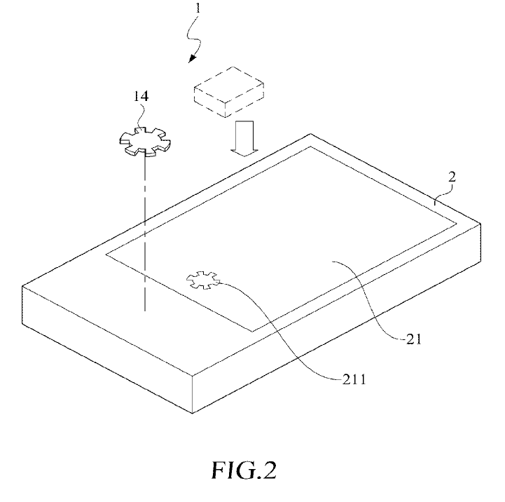

Referring now to FIG. 1 and FIG. 2, FIG. 1 is a functional diagram illustrating a control apparatus being implemented into a portable electronic device in accordance with one embodiment of the present invention; FIG. 2 is a perspective view of the control apparatus of the present invention integrated in a portable electronic device of the present invention. An electronic control apparatus 1 may comprise a motion sensor module integrated in a portable electronic device 2 for controlling a display 21 of the portable electronic device 2. The portable electronic device 2 may be a smartphone, a PDA, a portable GPS device or other entertainment or media playing, viewing devices. According to one embodiment of the present invention, the electronic control apparatus 1 comprises a processing unit 11, an analogue-to-digital (A/D) signal convertor 12, a sensing module 13 and an operation pad or touch panel 14.

In one embodiment of the present invention, the processing unit 11 may be embedded with an algorithm 111, comprising a preset first threshold angle, a second threshold angle, a first threshold acceleration value and a second threshold acceleration value. Furthermore, the processing unit 11 may be electrically connected to the sensing module 13 via the A/D (analogue to digital) convertor 12, i.e., the A/D signal convertor 12 may be electrically connected to both the processing unit 11 and the sensing module 13.

The sensing module 13 comprises an accelerometer or axial acceleration sensing unit 131, a gyroscope or angular velocity sensing unit 132, a magnetometer or magnetic-field sensing unit 133 and a touch-panel sensor module or operation pad sensing unit 134. In one embodiment, the axial acceleration sensing unit 131 may be for example a gravity sensor (G sensor), the angular velocity sensing unit 132 maybe for example a gyroscope, and the magnetic field sensing unit 133 may be for example a magneto-impedance sensor or a magnetic reluctance sensor. In one embodiment, the operation pad or touch panel 14 may be an integral part of the portable electronic device 2, and an operation pad icon 211 associated with a user-interface (UI) of the display 21 of the portable electronic device 2 may be displayed thereon and serve as an example of said operation pad 14. In other words, it can be understood that in known arts or under common usage of electronic device with a touch-panel, user inputs must be entered or inputted via the operation pad icon and must be carried out on or via the touch panel such that user input or actions to control the display of the electronic device including such as display content zoom in, zoom out, flip, rotate on the display or touch panel may be achieved. As mentioned previously, such limitation on the use of user input and control of a display of electronic device may hinder user's friendliness of use in various applications including gaming, media viewing and playing.

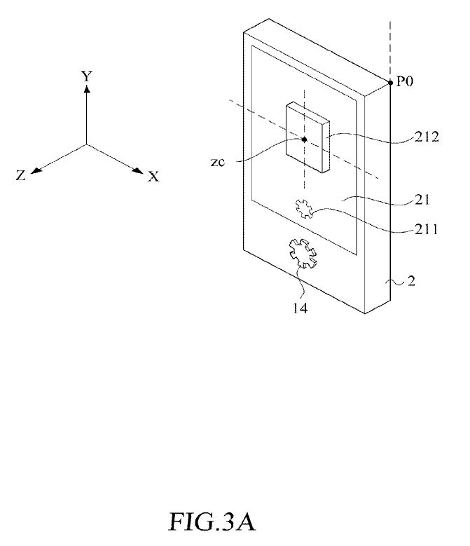

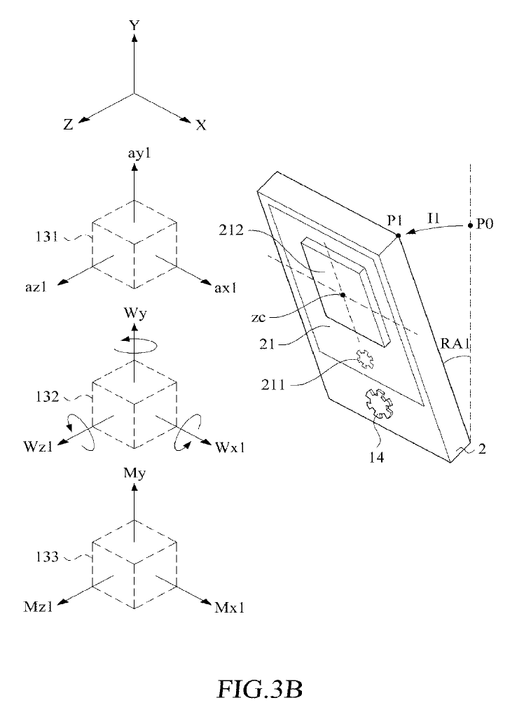

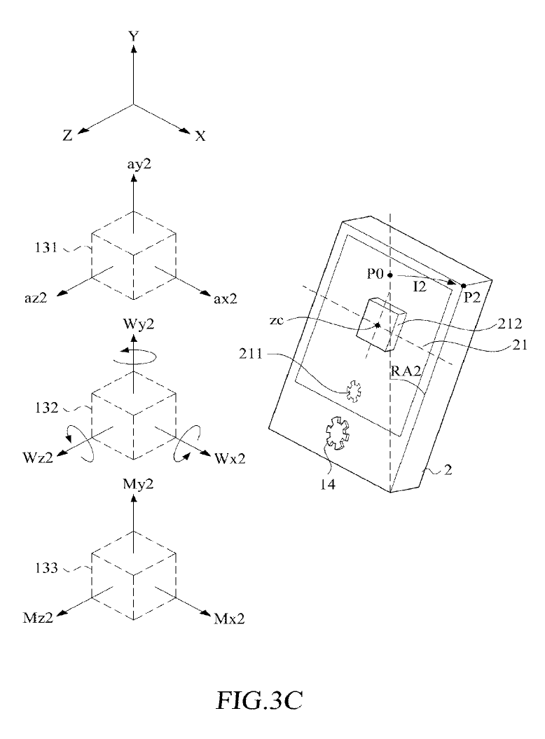

FIG. 3A to FIG. 3B illustrate the control method for zooming in or zooming out the display field of the display of the portable electronic device according to one embodiment of the present invention. The sensing module has a reference coordinate system X-Y-Z. Initially, the display 21 displays an object 212. When a user intends to zoom in the display field of the display 21, he/she can determine a zoom-in center ZC. If the user does not determine the zoom-in/out center ZC, a center point of the display field is preset to be the zoom-in center ZC. Then he/she may then trigger a triggering member such that the portable electronic device of the present invention may responsively enter a smart operation mode and such that the sensing unit comprising a motion sensor module may sense rotations and/or movements of the portable electronic device integrated with the sensing unit therein in steps described in the following content. in one embedment, the triggering member may be an example of the abovementioned operation pad 14 or the operation pad icon 211 associated with a user-interface (UI) stored in a register of the portable electronic device and displayed on the display 21 thereof to respond to an user input or selection.

During operation, in one exemplary embodiment, the user may hold the portable electronic device 2 and the portable electronic device 2 may be subject to rotations and/or movements due to external forces exerted by the user such that the rotations and/or movements of the portable electronic device 2 may be detected by a first rotation means. During a smart operation mode as mentioned previously, the axial acceleration sensing unit or accelerometer 131 may be configured to sense or detect three axial acceleration components Ax1, Ay1 and Az1; the angular velocity sensing unit or gyroscope 132 may be configured to sense or detect three angular velocity components Wx1, Wy1 and Wz1; and the magnetism sensing unit or magnetometer 133 may be configured to sense three magnetic field deviation components Mx1, My1 and Mz1. The axial acceleration sensing components Ax1, Ay1, Az1, the angular velocity sensing components Wx1, Wy1, Wz1, and the magnetic field sensing components Mx1, My1 and Az1 may be categorized as or combined in one form of signal such as a first rotation sensing signal S1a comprising said sensing components; and the first rotation sensing signal S1a may be transmitted to the processing unit 11. The first rotation sensing signal S1a may be converted by the A/D signal convertor 12 prior to the transmission to the processing unit 11 such that the first rotation sensing signal S1 may be converted from an analogue signal to a digital signal for further process or calculation of rotation angles by the processing unit 11.

As shown in FIG. 3A-3C, an exemplary reference coordinate may be denoted by x-axis, y-axis and z-axis. In addition, with reference to a universal coordinate system widely adapted in navigation, a rotation about the x-axis may be known as a pitch, a rotation about the y-axis may be a yaw and a rotation about the z-axis may be a roll. In one embodiment, the first rotation means may be configured to sense or detect a rotation of a pitch or about the x-axis as shown in the figure, of the portable electronic device 2 in a forward and backward manner to generate a first rotation angle RA1, i.e., the portable electronic device 2 may be positioned or held initially in a direction vertical to the horizontal plane such that the portable electronic device 2 may be rotated about a horizontal axis or, to be more specific, forwardly and backwardly along a forward rolling direction I1 as shown in the figure and one corner of the portable electronic device may be moved from an initial point P0 to another point P1. It can, however, be understood that other coordinate systems of yaw, pitch and roll may too be possible; any changes of denotation shall to be considered within the scope and spirit of the present invention.

To responsively control a display content or a media content stored in a register of the portable electronic device 2 of the present invention, the processing unit 11 may send out a control signal in response or corresponding to the rotation angle or rotation sensing signals received and calculated thereby. When the processing unit 11 receives the first rotation sensing signal S1a, the algorithm means 111 may calculate the rotation angle RA1 and further determine whether the rotation angle RA1 is greater than the first threshold angle. If the rotation angle RA1 is greater than the first threshold angle, the processing unit 11 then sends Out a zoom-in signal S2a to control the display 21 to zoom in the display field, and then the object 212 can be enlarged.

Similarly, in one example of responsively zooming out the display content on the display field of the display 21, the processing unit 11 may too output a control signal based on rotation and/or movement of the portable electronic device 2 detected by the first rotation means. In one embodiment of the present invention and preferably operating in the above mentioned smart operation mode, the acceleration sensing unit 131 may be configured to sense three acceleration components Ax2, Ay2 and Az2; the angular sensing unit 132 may be configured to sense three angular velocity components Wx2, Wy2 and Wz2; and the magnetic field sensing unit 133 may be configured to sense three magnetic field deviation components Mx2, My2 and Mz2. The acceleration components Ax2, Ay2, Az2, the angular velocity components Wx2, Wy2, Wz2, and the magnetic field deviation components Mx2, My2 and Mz2 can be sent out via the first rotation sensing signal S1a, and the first rotation sensing signal S1a may be transmitted to the processing unit 11. In one embodiment, the first rotation means may be configured to detect a rotation of a pitch of the portable electronic device 2 about the x-axis as shown in the figure in a backward manner to generate another first rotation angle RA2. The portable electronic device 2 may be positioned or held in a direction vertical to the horizontal plane in initial and the portable electronic device 2 may be pitched or rotated about the x-axis in a backward manner; the rolling direction 12 as shown in the figure indicates movement of a corner of the portable electronic device move from an initial point P to another point P2. During an explanatory operation of the present invention, the processing unit 11 may be embedded with an algorithm for calculation and determination of rotation angles based on rotation sensing angle signals received from the sensing module. When the processing unit 11 receives the first rotation sensing signal S1a, the processing unit 11 embedded with the algorithm means 111 may calculate the rotation angle RA2 and further determine whether the rotation angle RA2 is greater than the first threshold angle, If the rotation angle RA2 is greater than the first threshold angle, the processing unit 11 may then send out a zoom out signal S2a to control the display 21 to zoom in the media content displayed on the display field of the display 21.

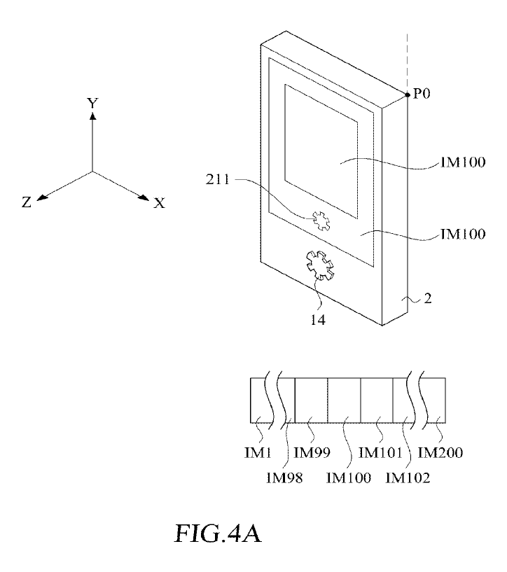

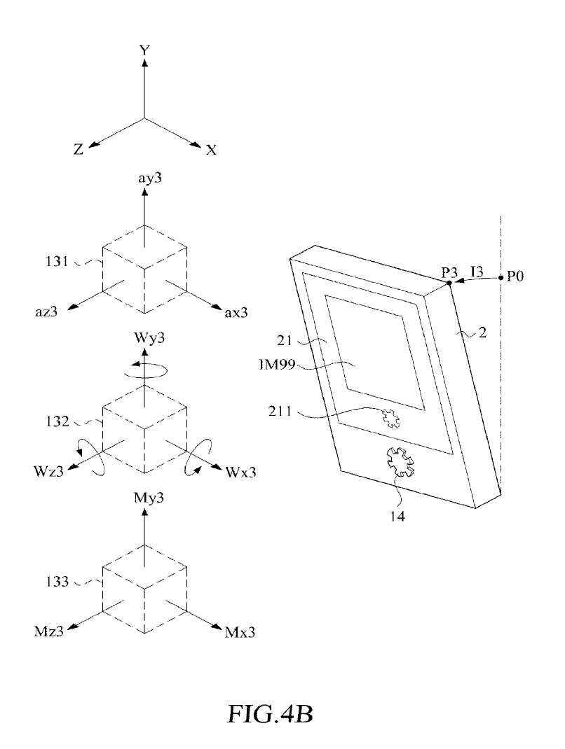

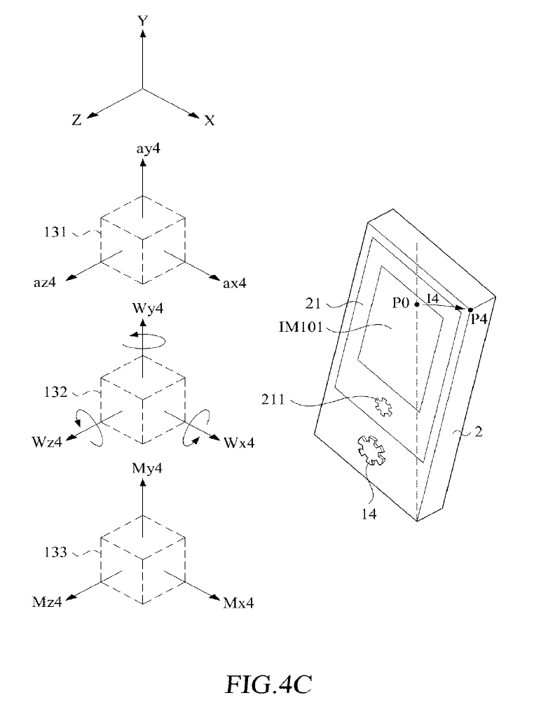

FIG. 4A to 4C show an exemplary embodiment of the control method of the present invention in which pages or images of a media content stored in a register of the portable electronic device 2 of the present invention is flipped to display a previous or next page/image of the media content on display thereof. In one embodiment, The portable electronic device 2 also can be operated to display a plurality of images IM1˜IM200, which may too be part of a media content or display content comprising such as image files stored in a register of the portable electronic device 2; the media content may too be for example web-site pages, video, document, music.

During an explanatory operation example of the present invention, And preferably in a smart operation mode, the user may exert an external force to rotate the portable electronic device such that the rotation may result in making the display 21, initially displaying for example an image IM100, to flip an image of a media content on the display such as the front image IM99 and wherein the rotation of the portable electronic device 2 may be detected by a second rotation means. At this moment under the smart operation mode, the acceleration sensing unit 131 can sense three acceleration components Ax3, Ay3 and Az3; the angular sensing unit 132 can sense three angular velocity components wx3, wy3 and wz3; and the magnetic field sensing unit 133 can sense three magnetic field deviation components Mx3, My3 and Mz3. The acceleration components Ax3, Ay3, Az3, the angular velocity components Wx3, Wy3, Wz3, and the magnetic field deviation components Mx3, My3 and Mz3 may categorized as or combined in one form of signal such as the acceleration sensing signal S1b for further transmission to and process by the processing unit 11. The acceleration sensing signal S1b may be transmitted to the processing unit 11. Likewise, in one embodiment, the second rotation means may be configured to detect a rotation of a yaw, such as the rotation about the y-axis as shown in the figure, of the portable electronic device 2 and may be for example in a counterclockwise direction 13 to generate an acceleration value. In other words, in one embodiment, the portable electronic device 2 may be positioned or held in a direction vertical to the horizontal plane as shown in the figure and may be yawed such that one corner of the portable electronic device may be moved from an initial point P0 to another point P3 as shown in the figure. As the processing unit 11 receives the acceleration sensing signal S1b from the sensing module, the processing unit 11 embedded with an algorithm means 111 may then calculate the acceleration value and further determine whether the acceleration value is greater than the first threshold acceleration value. If the acceleration value is greater than the first threshold acceleration value, the processing unit 11 then sends out a starting page-switch signal S2b to control the media content on the display field of the display 21 to display for example the front image IM99.

Likewise, in another example of the present invention, a user may exert a force on the portable electronic device 2 to cause it to rotate about a y-axis to make a yawing of the device 2. While being subject to the such rotation of yawing, the processing unit 11 integrated therein may calculate and determine the yaw angle and to send out a display control signal such that the media content displayed on the display field of the display 21 may flip to a next page or image IM101; and wherein the rotation of the portable electronic device 2 may be detected by the second rotation means. In a smart operation mode, the acceleration sensing unit 131 may be configured to sense three acceleration components Ax4, Ay4 and Az4; the angular sensing unit 132 may be configured to sense three angular velocity components Wx4, Wy4 and Wz4; and the magnetic field sensing unit 133 may be configured to sense three magnetic field deviation components Mx4, My4 and Mz4. The acceleration components Ax4, Ay4, Az4, the angular velocity components Wx4, Wy4, Wz4, and the magnetic field deviation components Mx4, My4 and Mz4 may be categorized as or combined in one form of signal such as the acceleration sensing signal S1b. The acceleration sensing signal S1b may be further transmitted to and processed by the processing unit 11. In one embodiment, the second rotation means may be configured to detect a rotation of a yaw of the portable electronic device 2 about a y-axis in a clockwise direction 14 to generate another acceleration value. As shown in the figure, the clockwise direction 14 rotation of the yaw may cause a corner of the portable electronic device to move from an initial point P0 to another point P4. When the processing unit 11 receives the acceleration sensing signal S1b, the processing unit 11 embedded with an algorithm means 111 may be configured to calculate the acceleration value and further determine whether the acceleration value is greater than the first threshold acceleration value. If the acceleration value is greater than the first threshold acceleration value, the processing unit 11 may then send out a starting page-switch signal S2b to control the media content on the display filed of the display 21 to display a change of image of the media content such as the displaying of a next page or image IM101 changed or switched from a previous page or image.

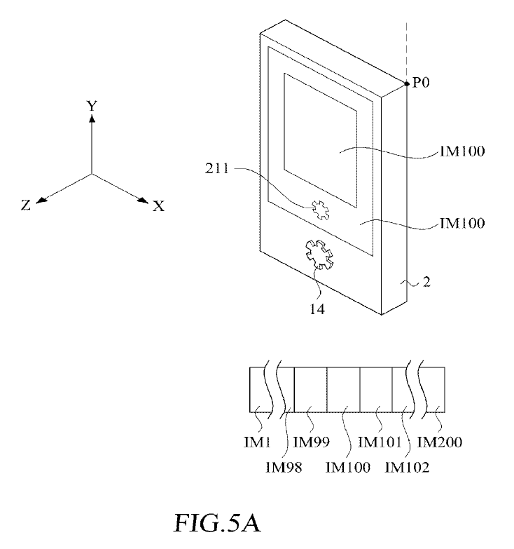

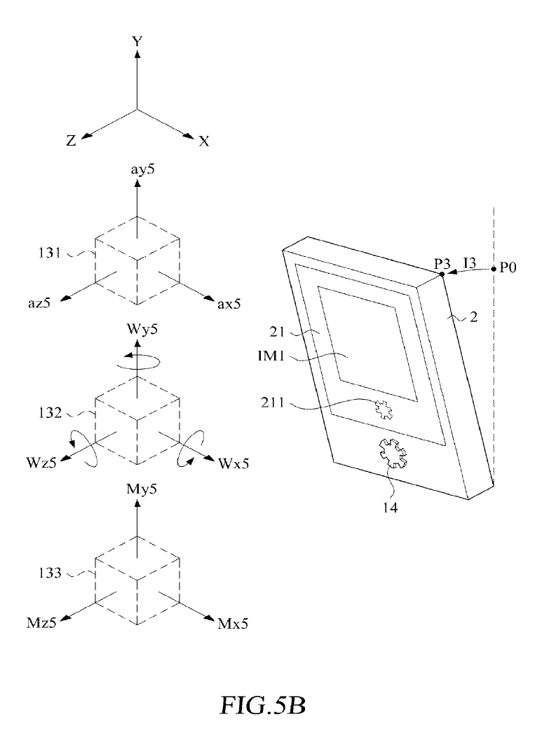

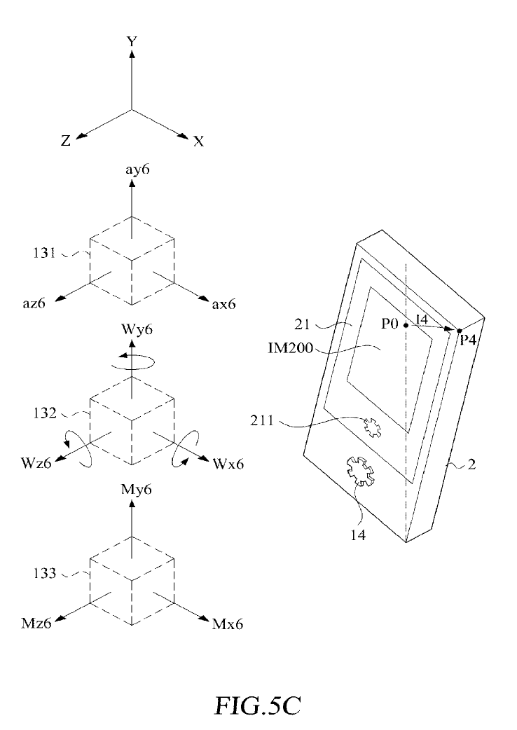

FIG. 5A to 5C show an explanatory embodiment of a responsive control method of the present invention in which a media content on the display field of the display 21 may be responsively altered or changed to show a first or last image of the media content. Likewise and with reference to the above description, a user may exert a force to rotate the portable electronic device 2 and such rotation may be detected by the abovementioned second rotation means. The acceleration sensing unit 131 may be configured to sense three acceleration components Ax5, Ay5 and Az5; the angular sensing unit 132 may be configured to sense three angular velocity components Wx5, Wy5 and Wz5; and the magnetic field sensing unit 133 may be configured to sense three magnetic field deviation components Mx5, My5 and Mz5. The acceleration components ax5, ay5, az5, the angular velocity components wx5, wy5, wz5, and the magnetic field deviation components Mx5, My5 and Mz5 may be categorized as or combined in one form of signal such as the acceleration sensing signal S1b. The acceleration sensing signal S1b may be transmitted to and processed by the processing unit 11. In one embodiment, the second rotation means may be configured to detect a rotation about the y-axis as shown in the figure, or yawing, of the portable electronic device 2 and for example in a counterclockwise direction 13 to generate a greater acceleration value. When the processing unit 11 receives the acceleration sensing signal S1b, the processing unit 11 embedded with an algorithm means 111 may calculate the acceleration value and further determine whether the acceleration value is greater than the second threshold acceleration value. If the acceleration value is greater than the second threshold acceleration value, the processing unit 11 may then send out a destination page-switch signal S2c to control the media content on the display field of the display 21 to display for example a first image IMI of the media content. Similarly, in another embodiment, upon receiving the acceleration sensing signal S1b, the processing unit 11 embedded with the algorithm means 111 may calculate the acceleration value and further determine whether the acceleration value is greater than the second threshold acceleration value. If the acceleration value is greater than the second threshold acceleration value, the processing unit 11 sends out a destination page-switch signal S2c to control the media content on the display field of the display 21 to display for example the last image IM200 of the media content stored in the register of the portable electronic device.

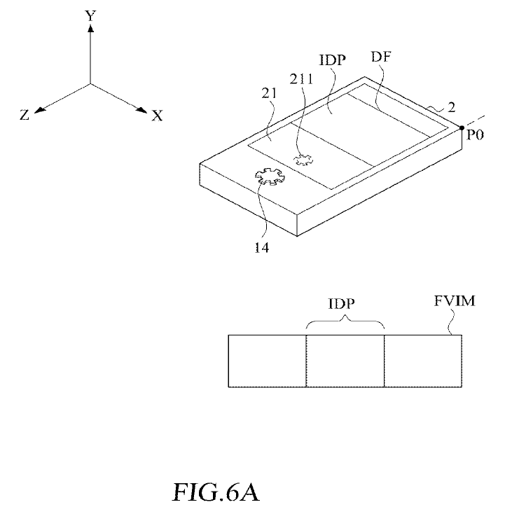

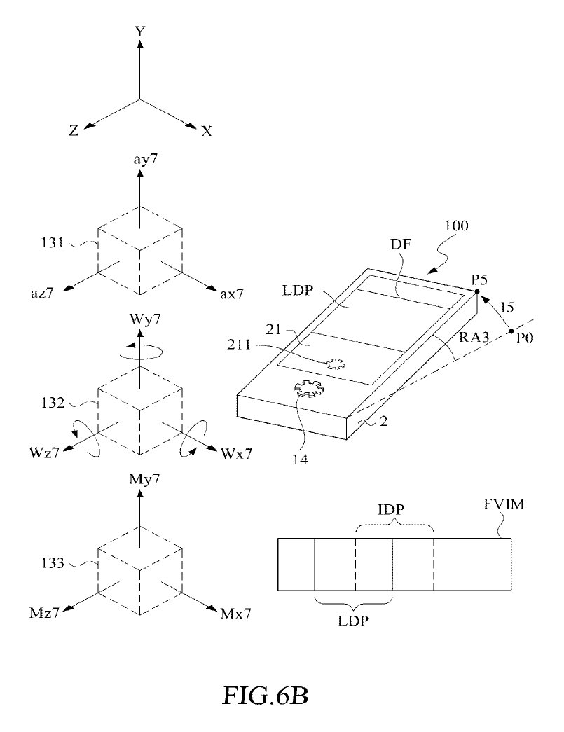

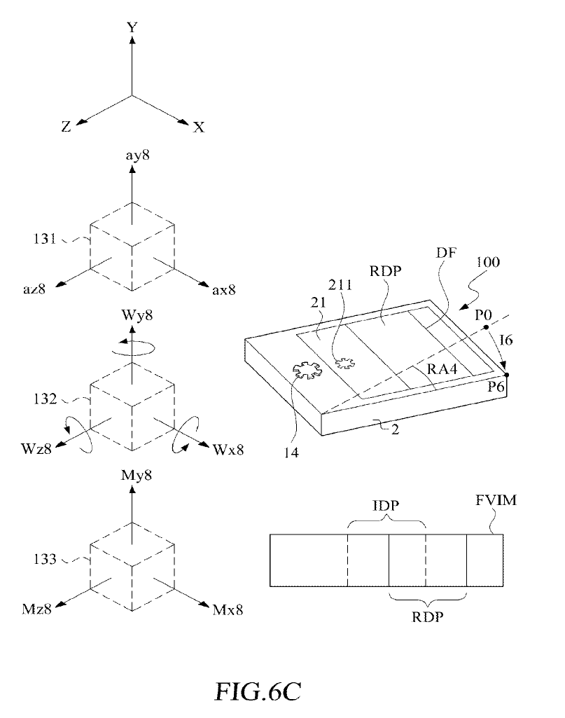

Please refer to FIG. 6A to 6C. According to an explanatory embodiment of a responsive control method of the present invention, in which a media content stored in a register of the portable electronic device 2 and displayed on a display field of the display 21 may be controlled to be displaced such that a full-view image or page of the media content may show different portions thereof in response to motion sensor signals received from a sensing module integrated in the device of the present invention. In another embodiment, the full view image FVIM can be a 360-degree full view of an image of the media content. In still yet another embodiment, a media content of a non-full view image on the display field DF of the display 21 may too be enlarged or switched to a full-view image FVIM thereof in response the abovementioned motion sensor signals received from the sensing module and processed by the processing unit 11 integrated therein.

In one embodiment and during operation of the present invention, a user may exert an external force on the portable electronic device 2 to rotate the device about an axis and a media content displayed on the display field of the display 21 thereof may responsively move from an initial display part IPD to another display part such as a left display part LPD; wherein the rotation of the portable electronic device 2 of the present invention may be detected by a third rotation means. The acceleration sensing unit 131 of a sensing module may be configured to sense three acceleration components Ax7, Ay7 and Az7; the angular sensing unit 132 may be configured to sense three angular velocity components Wx7, Wy7 and Wz7; and the magnetic field sensing unit 133 may be configured to sense three magnetic field deviation components Mx7, My7 and Mz7. The acceleration components Ax7, Ay7, Az7, the angular velocity components Wx7, Wy7, Wz7, and the magnetic field deviation components Mx7, My7 and Mz7 may be categorized as or combined in one signal form as a second rotation sensing signal S1c. The second rotation sensing signal S1c may then be transmitted to and further processed by the processing unit 11. In one embodiment, the third rotation means may be configured to detect a rotation of a roll, such as about the z-axis as shown in the figure, of the portable electronic device 2 and for example in a counterclockwise direction I5 as shown to generate a second rotation angle RA3. As shown in the figure, the portable electronic device 2 may be held in a planer position to roll on a certain axis. It can be understood that different coordinate system and denotations are also possible. For example, according to a universal coordinate system in navigation, a roll may be defined as a rotation about a z-axis. Therefore, in another embodiment, the portable electronic device 2 of the present invention may be rolled about the z-axis in for example a counterclockwise direction I5 to such that a corner of the portable electronic device may move from an initial point P0 to another point P5. Upon receiving the second rotation sensing signal S1c, the processing unit 11 embedded of an algorithm means 111 may calculate the second rotation angle RA3 and further determine whether the second rotation angle RA3 is greater than the second threshold angle. If the second rotation angle RA3 is greater than the second threshold angle, the processing unit 11 may then send out a field-moving signal S2d to control the display 21 to display different portions of a full-view image or page of the media content on the display filed of the display 22, for example responsively moving the media content to show or display the left display part LPD of the full view image FVIM thereof. Similarly, the processing unit 11 may too send out a field-moving signal S2d to control the media content on the display field of the display 21 to show or display the right display part RPD of the full view image FVIM thereof.

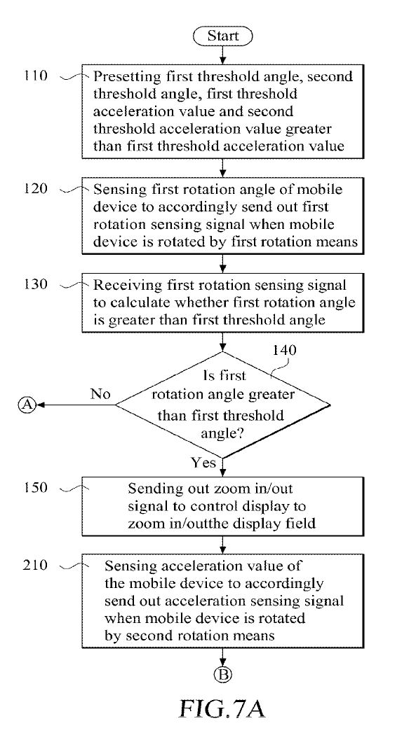

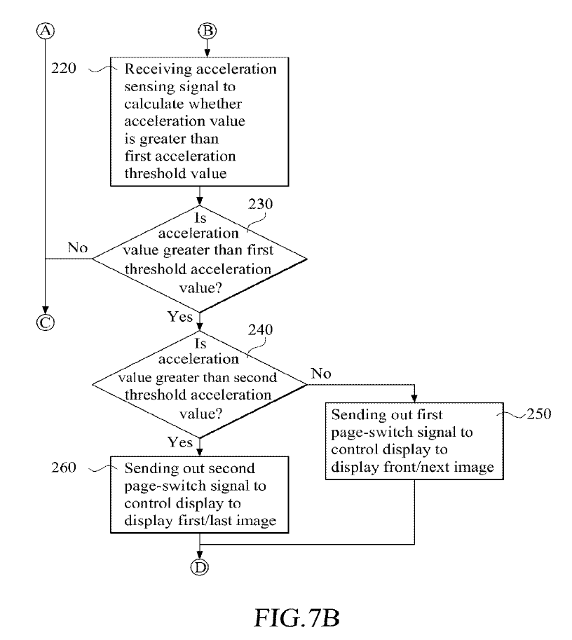

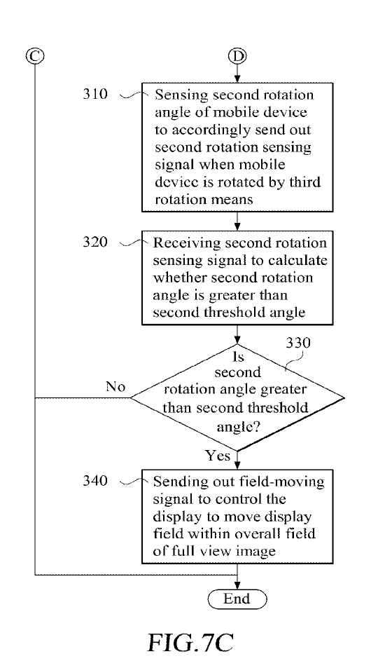

FIG. 7A to FIG. 7C show an illustrative flowchart of a responsive control method of the present invention in which a media content on a display field of a display 21 of the portable electronic device 2 of the present invention carries out the abovementioned zooming in or zooming out of the media content, flipping to a previous or next image/page, switching to a first or last image/page, and displacing different portions of a full-view image on a display field of a display of the portable electronic device of the present invention. In one embodiment, the control method may be performed by a portable electronic device embedded with a control apparatus comprising motion sensors or sensing module, in particular the method may be preferably carried out by a processing unit integrated therein. The control method may comprise a preset first threshold angle, a second threshold angle, a first threshold acceleration value and a second threshold acceleration value that may be greater than first threshold acceleration value as shown in step 110. When executing the function of zooming in/out a media content on a display field, a sensing module may first sense or detect the first rotation angle RA1 or RA2 of a portable electronic device 2 and may send out a first rotation sensing signal S1a in response to a rotation of the portable electronic device 2 detected by a first rotation means (step 120). Upon receiving said first rotation sensing signal S1a, a processing unit 11 embedded with an algorithm and integrated in portable electronic device 2 as well as electrically connected to the sensing module may then calculate and determine whether the first rotation angle RA1 is greater than the first threshold angle (step 130). In another embodiment, the method may also include the step of determining whether the first rotation angle RA1 or RA2 is greater than the first threshold. angle (step 140). If the first rotation angle RA1 or RA2 is greater than the first threshold angle, the processing unit may then send out a display control signal or a zoom in/out signal S2a to responsively control said media content stored in the register of the portable electronic device 2 to zoom in or zoom out the media content on the display field (step 150).

In another embodiment of the present invention, a responsive control method to alter a media content displayed on a display field of a display of a portable electronic device integrated with a processing unit and a sensing module is explanatory illustrated. In other to flip to a previous or next image or switching to a first or last image/page of the media content stored therein and displayed on the display field, an acceleration value of the portable electronic device may be sensed or detected by the sensing module an acceleration sensing signal S1b may be transmitted to and processed by a processing unit as a rotation of the portable electronic device is detected by a second rotation means (step 210). Following which and upon receiving the acceleration sensing signal, the processing unit embedded with an algorithm may perform a calculation and determine whether the acceleration value is greater than the first acceleration threshold value (step 220). In another embodiment, the processing unit may too determine whether the acceleration value is greater than first threshold acceleration value (step 230). If the acceleration value is greater than the first threshold acceleration value, the processing unit may further determine whether the acceleration value is greater than the second threshold acceleration value (step 240). If the acceleration value is not greater than the second threshold acceleration value, the processing unit may then send out a display control signal or a starting page-switch signal S2b to control the media content on the display field of the display 21 and for example to display or flip to a previous or next image IM99 or IM101 (step 250). If the acceleration value is greater than the second threshold acceleration value, is the processing unit may then send out a destination page-switch signal S2c to control the media content on the display field of the display 21 to display or switch to a first or last image IM1 or IM200 (step 260).

In still another embodiment of the present invention, a responsive control method may be utilized by a portable electronic device 2 integrated with a sensing module comprising motion sensors and a processing unit to responsively displace a media content on a display field of a display 21 of the device, and in particular, to sense a second rotation angle RA3 or RA4 of the portable electronic device 2 and to transmit a second rotation sensing signal S1c as a rotation of the portable electronic device 2 is detected by a third rotation means (step 310). In one embodiment, after step 310, and upon receiving the second rotation sensing signal S1c, the processing unit embedded with an algorithm may then calculate and determine whether the second rotation angle RA3 or RA4 is greater than second threshold angle (step 320); the processing unit may too further determine whether the second rotation angle RA3 or RA4 is greater than second threshold angle (step 330). If the second rotation angle RA3 or RA4 is greater than second threshold angle (step 330), the processing unit of the portable electronic device of the present invention may send out a field-moving or displacement signal Std of a display control signal to control the media content on the display filed of the display 21 of the portable electronic device to displace different portions of a full-view image of the media content on display field DF (step 340).

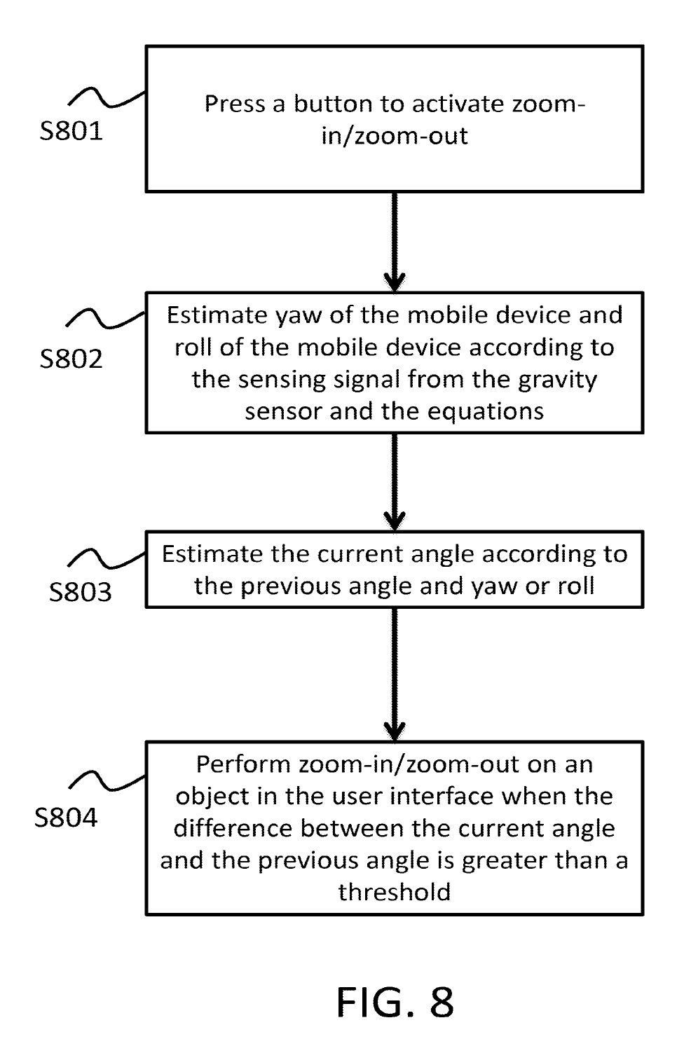

FIG. 8 shows a flow chart of a method of controlling a mobile device configured with a motion sensor according to a first embodiment of the present invention. Please refer to FIG. 8. The method of controlling the mobile device with the motion sensor according to the first embodiment of the present invention includes the following steps: step S801 is pressing a button to activate zoom-in/zoom-out; and tilting a mobile device; step S802 of estimating yaw and roll of the mobile device according to the sensing signal from the gravity sensor and two equations, namely Equation 1, and Equation 2, in which Equation 1 is expressed for solving pitch as follow:

Pitch=tan⁻¹(ay/az) Equation 1

And Equation 2 is expressed for solving roll as follow:

Roll=tan⁻¹(ax/√ay²+az²) Equation 2;

step S803 is of estimating the current angle according to the previous angle and the estimated yaw or the estimated roll; step S804 is of performing zoom-in/zoom-out on an object in the user interface when the difference between the current angle and the previous angle is greater than a threshold.

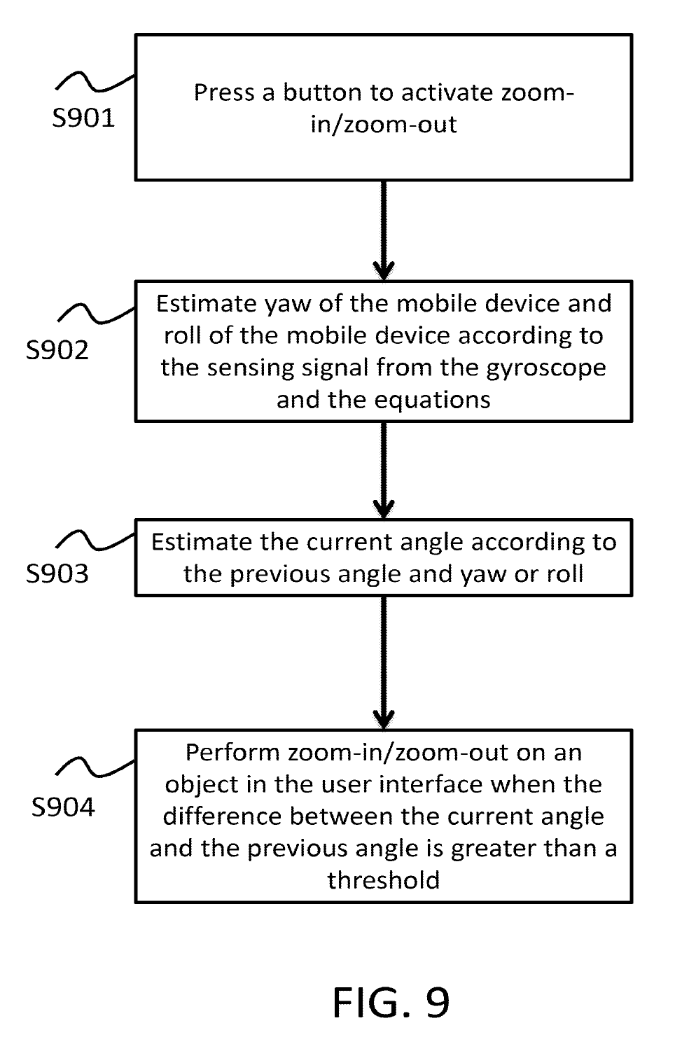

FIG. 9 shows a flow chart of a method of controlling the mobile device configured with a motion sensor according to a second embodiment of the present invention. Please refer to FIG. 9. The method of controlling a mobile device configured with a motion sensor according to the second embodiment of the present invention includes the following steps: step S901 is of pressing a button to activate zoom-in/zoom-out; and tilting a mobile device; step S902 is of estimating yaw and roll of the mobile device according to the sensing signal from the gyroscope and two equations as follow, namely Equations 3 and 4, where Equation 3 is used for solving for pitch

Pitch=∫wx(t)dt Equation 3

and Equation 4 is used for solving for roll:

Roll=∫wz(t)dt Equation 4;

step S903 is of estimating the current angle according to the previous angle and yaw or roll; step S904 is of performing zoom-in/zoom-out on an object in the user interface when the difference between the current angle and the previous angle is greater than a threshold.

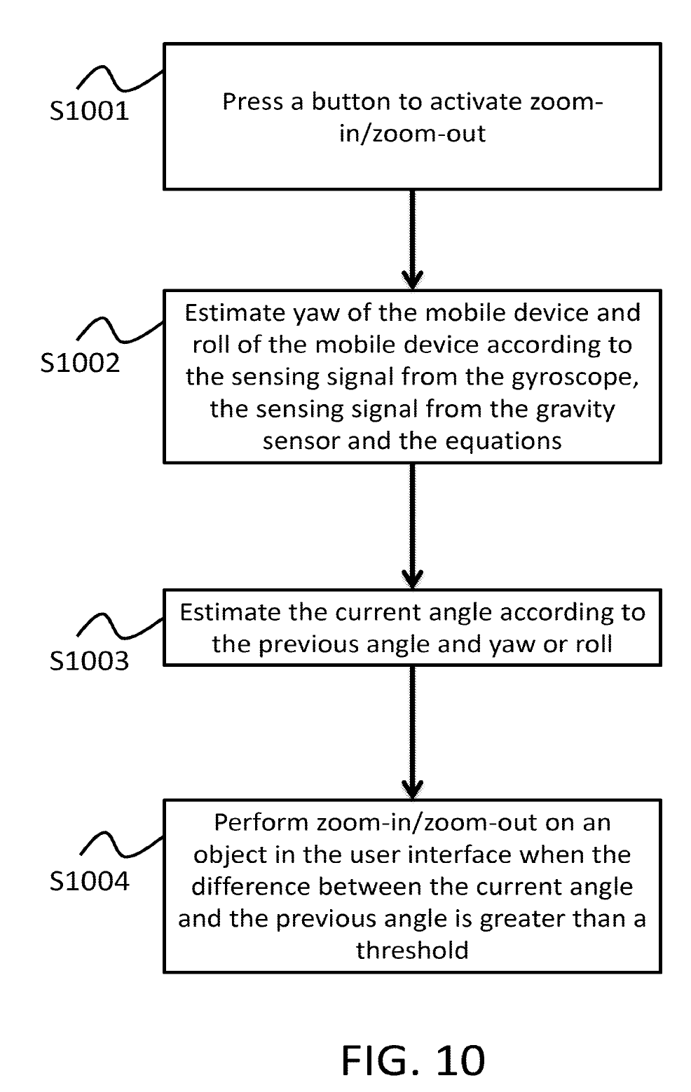

FIG. 10 shows a flow chart of a method. of controlling the mobile device configured with a motion sensor according to the third embodiment of the present invention. Please refer to FIG. 10. The method of controlling the mobile device with the motion sensor according to the third embodiment of the present invention includes the following steps: step S1001 is of pressing a button to activate zoom-in/zoom-out, and of tilting a mobile device; step S1002 is of estimating yaw and roll of the mobile device according to the sensing signal from the gyroscope, the sensing signal from the gravity sensor, Equations 3, 4 and Equations 5, 6 as follow, respectively:

Pitch=tan⁻¹(ay/az) Equation 5,

Roll=tan⁻¹(ax/√ay²+az²) Equation 6,

step S1003 is of estimating the current angle according to the previous angle and yaw or roll; step S1004 is of performing zoom-in/zoom-out on an object in the user interface when the difference between the current angle and the previous angle is greater than a threshold.

The method of controlling the mobile device with the motion sensor according to the third embodiment of the present invention utilized the gyroscope and the gravity sensor. When the gyroscope detects a high rotation speed, for example, 300 degrees per second, the sensing signal from the gyroscope may be analyzed to generate yaw and roll because the gravity sensor could not extract the gravity and the centrifugal force. In addition, the gyroscope generates the accumulated error as time goes by. The gyroscope also detects relative rotation, but not absolute rotation. Therefore, the gravity sensor may be used to correct the accumulated error and the relative angle generated by the gyroscope.

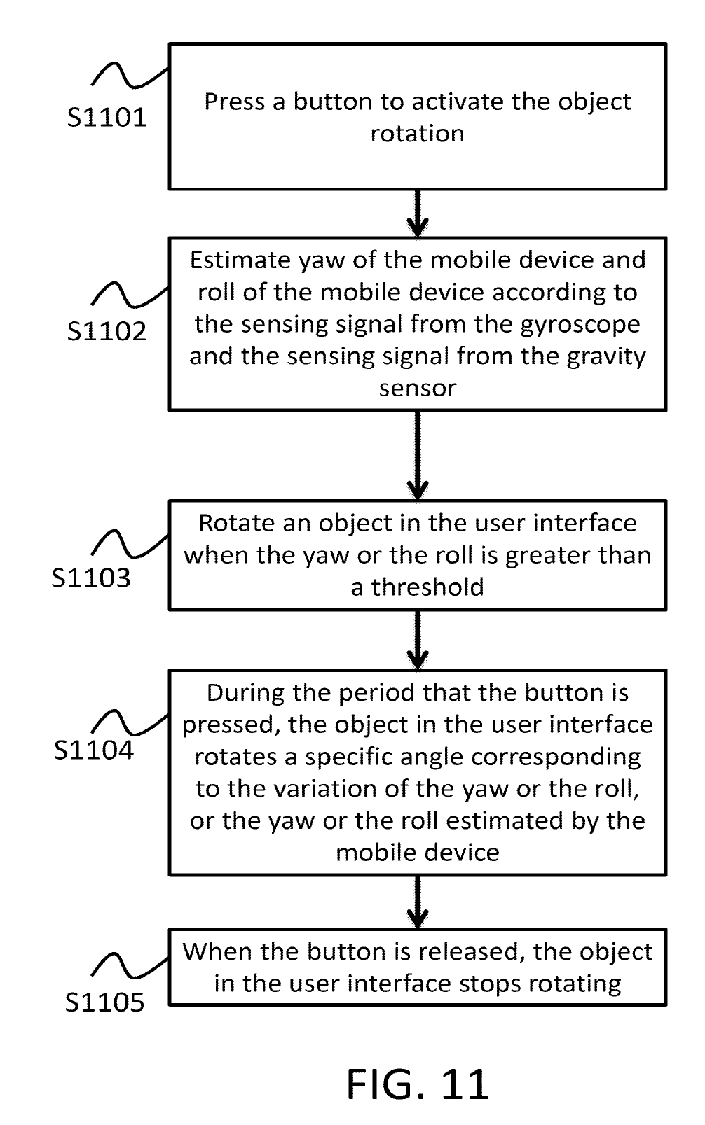

FIG. 11 shows a flow chart of a method of controlling the mobile device configured with a motion sensor according to a fourth embodiment of the present invention. Please refer to FIG. 11. The method of controlling a mobile device configured with a motion sensor according to the fourth embodiment of the present invention includes the following steps: step S1101 is of pressing a button to activate the object rotation, and of rotating a mobile device; step S1102 is of estimating yaw and roll of the mobile device according to the sensing signal from the gyroscope and the sensing signal from the gravity sensor; step S1103 is of rotating an object in the user interface when the yaw or the roll is greater than a threshold. During the period that the button is pressed, the object in the user interface rotates a specific angle corresponding to the variation of the yaw or roll, or the yaw or the roll estimated by the mobile device (S1104). When the button is released, the object in the user interface stops rotating (S1105).

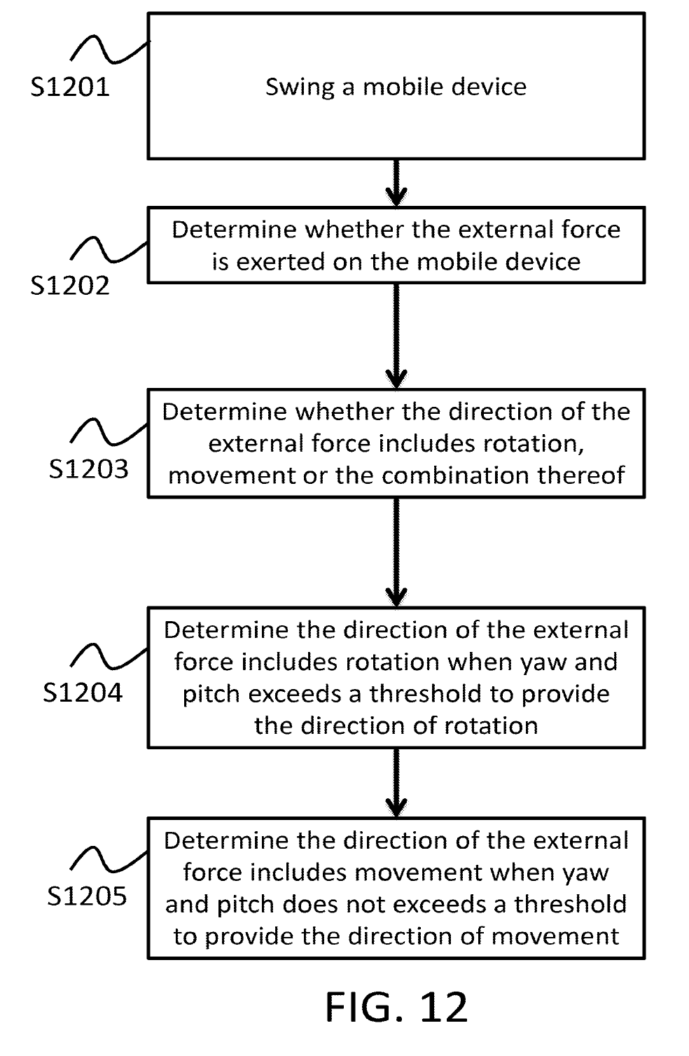

FIG. 12 shows a flow chart of a method of controlling a mobile device configured with a motion sensor according to a fifth embodiment of the present invention. Please refer to FIG. 12. The method of controlling the mobile device with the motion sensor according to the fifth embodiment of the invention includes the following steps. One of the steps is swinging a mobile device (S1201). One of the steps is determining whether the external force is exerted on the mobile device (S1202), for example, determining which acceleration in the x-axis, y-axis or the z-axis has the greatest value among thereof when the sum of the accelerations in x-axis, y-axis and z-axis exceeds a threshold. One of the steps is determining whether the direction of the external force includes rotation, movement or the combination thereof (S1203), for example, estimating yaw and pitch with the gyroscope. One of the steps is determining the direction of the external force includes rotation when yaw and pitch exceeds a threshold, for example, determining which acceleration in x-axis or z-axis is greater, to provide the direction of rotation (S1204), for example, determining the direction of rotation is yaw when the acceleration in the z-axis is greater than that in the x-axis. One of the steps is determining the direction of the external force includes movement when yaw and pitch do not exceeds a threshold, for example, determining which acceleration in the x-axis, y-axis or the z-axis has the greatest acceleration value amongst thereof, to provide the direction of movement (S1205). The above mentioned steps may be used in a display or a touch panel for turning to another page, for example, turning to the previous page, the next page, the starting page or the last page.

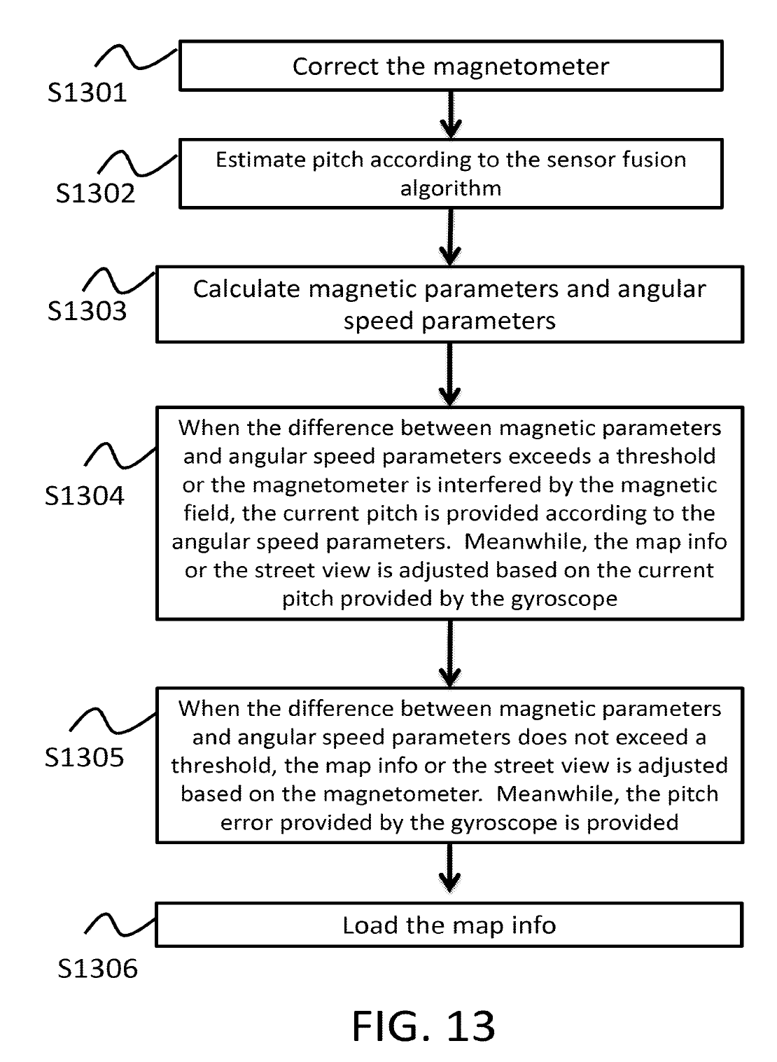

FIG. 13 shows a flow chart of a method of exploring the 360 degree panoramic street view in the horizontal plane configured with a motion sensor including the gyroscope and the magnetometer according to the embodiment of the present invention. Please refer to FIG. 13. The method of exploring the 360 degree panoramic street view in the horizontal plane with the motion sensor including the gyroscope and the magnetometer according to the embodiment of the present invention includes the following steps. One of the steps is correcting the magnetometer (S1301). One of the steps is estimating pitch according to the sensor fusion algorithm (S1302). One of the steps is calculating magnetic parameters and angular speed parameters (S1303). When the difference between the magnetic parameters and the angular speed parameters exceeds a threshold or the magnetometer is interfered by the magnetic field, the current pitch is provided according to the angular speed. parameters. Meanwhile, the map info or the street view is adjusted based on the current pitch provided by the gyroscope (S1304). When the difference between the magnetic parameters and the angular speed parameters does not exceed a threshold, the map info or the street view is adjusted based on the magnetometer readings. Meanwhile, the pitch error provided by the gyroscope is provided (S1305). One of the steps is loading the map info (S1306).

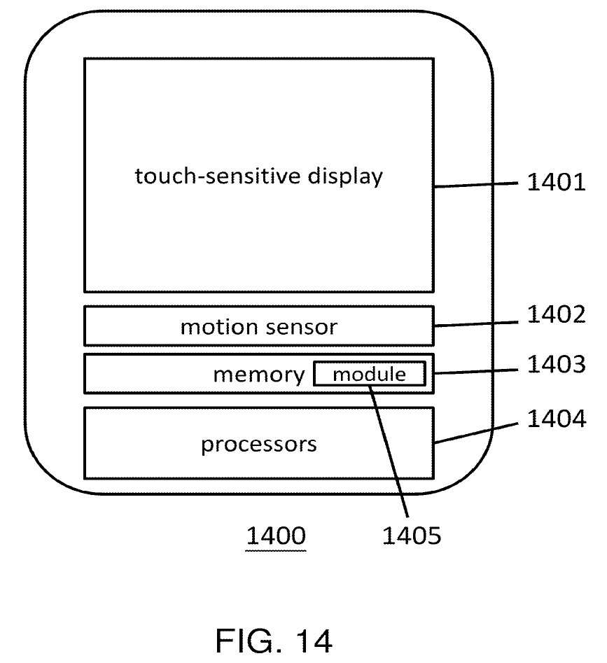

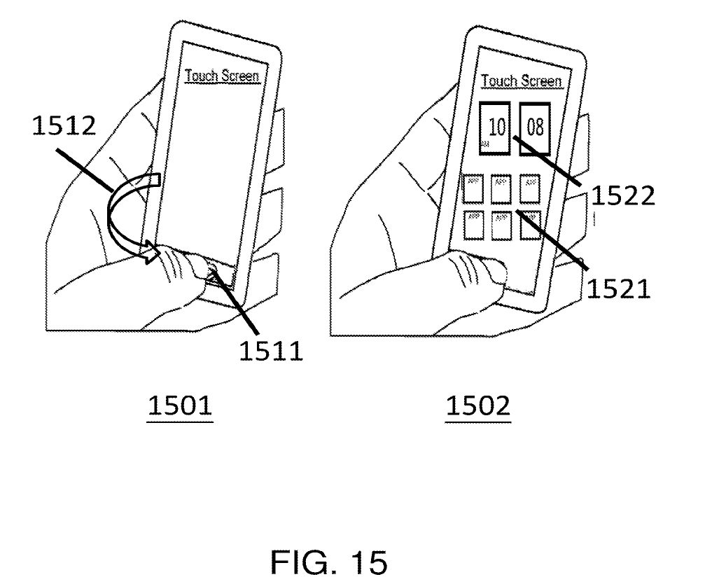

FIG. 14 shows a block diagram of a mobile device 1400 according to the embodiment of the invention. FIG. 15 shows an operation of the mobile device 1400 according to the embodiment of the invention. Referring to FIG. 14 and FIG. 15, the mobile device 1400 includes a touch-sensitive display 1401, a motion sensor 1402, a memory 1403, one or more processors 1404 and one or more modules 1405 stored in the memory 1403. The motion sensor 1402 includes at least one of a gravity sensor, a gyroscope or a magnetometer. The modules 1405 are configured for execution by the one or more processors 1404. The one or more modules 1405 include instructions for performing the following steps: the step of detecting a contact with the touch-sensitive display 1401 while the mobile device 1400 is in a first state to determine whether the contact corresponds to a predefined icon 1511; the step of detecting a rotation or a movement with the motion sensor 1402 while the mobile device 1400 is in the first state to determine whether the rotation or the movement corresponds to a predefined gesture 1512; and the step of transitioning the mobile device 1400 to a second state when the contact corresponds to the predefined icon 1511, and the rotation or movement corresponds to the predefined gesture 1512. For example, as shown in FIG. 15, the mobile device 1400 is transitioned from the user-interface lock state to a predefined state.

The predefined state may be a user-interface unlock state, which is the state for executing an application or the state for dialing the phone.

The mobile device 1400 may be transitioned to the second state 1502 when the contact corresponds to a predefined icon 1511, and the rotation or the movement corresponds to a predefined gesture 1512. The predefined icon 1511 may show a text message “hold and rotate to unlock” or an icon referring to “hold and rotate to unlock”. The predefined gesture 1512 may be a horizontal movement, a vertical rotation or the combination thereof In detail, the mobile device 1400 in the user-interface lock states shows lock info. The mobile device 1400 in the user-interface unlock state shows a plurality of icons 1521 and a clock 1522.

When the movement detected by the motion sensor 1402 is a horizontal movement and corresponds to a predefined gesture 1512, the mobile device 1400 may be transitioned from the user-interface lock state to the user-interface unlock state. When the rotation detected by the motion sensor 1402 is a vertical rotation and corresponds to a predefined gesture 1512, the mobile device 1400 may also be transitioned from the user-interface lock state to the state for dialing the phone.

When the contact does not correspond to the predefined icon 1511 or when the contact does correspond to the predefined icon 1511 but the rotation or the movement does not correspond to the predefined gesture 1512, the mobile device 1400 is maintained in the first state 1501. To be more specific, in response to detecting any contact with the touch-sensitive display 1401 that does not correspond to the predefined icon 1511 or in response to detecting any rotation or movement with the motion sensor 1402 that does not correspond to the predefined gesture 1512, while the mobile device 1400 is in the first state 1501, the mobile device 1400 prevents from performing a predefined set of actions. The actions may be dialing the phone, activating the camera, executing an application, or playing music.

It is noted that the method of determining whether the rotation or the movement corresponds to the predefined gesture 1512 is described in patent application Ser. No. 12/967,401, filed on Dec. 14, 2010, which is hereby incorporated by reference herein and made a part of this specification.

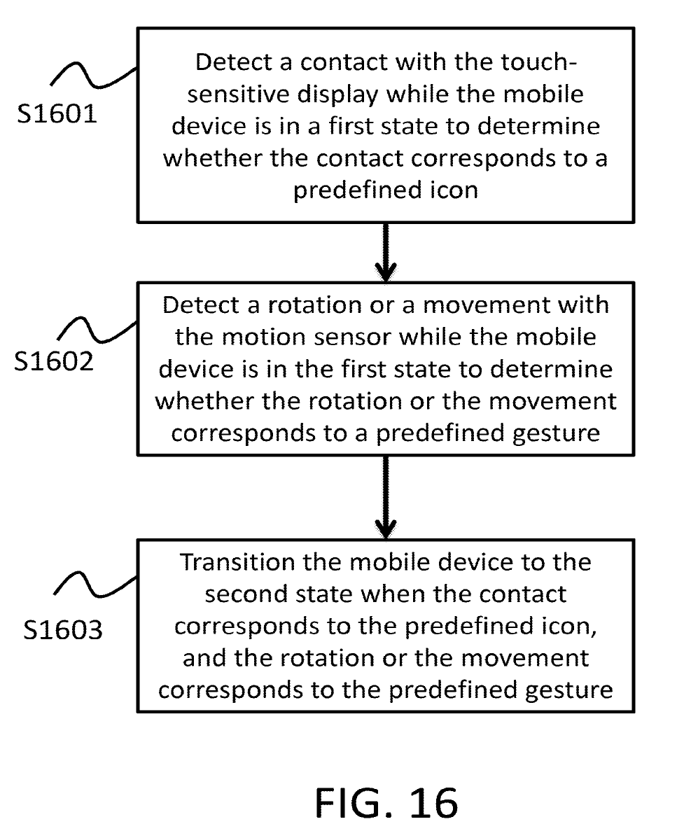

FIG. 16 shows a flow chart of a method of controlling a mobile device configured with a touch-sensitive display and a motion sensor according to the embodiment of the present invention. Please refer to FIG. 16. The method of controlling a mobile device configured with a touch-sensitive display and a motion sensor of the embodiment includes: the step S1601 of detecting a contact with the touch-sensitive display while the mobile device is in a first state to determine whether the contact corresponds to a predefined icon; the step S1602 of detecting a rotation or a movement with the motion sensor while the mobile device is in the first state to determine whether the rotation or the movement corresponds to a predefined gesture; and the step S1603 of transitioning the mobile device to a second state when the contact corresponds to the predefined icon, and the rotation or the movement corresponds to the predefined gesture.

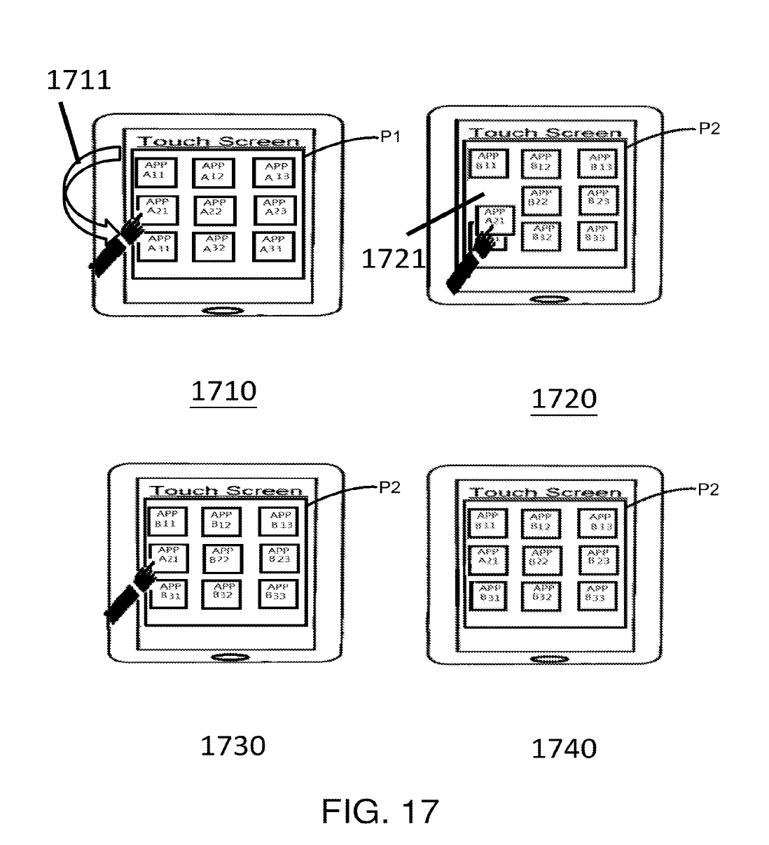

FIG. 17 shows another operation of the mobile device according to the embodiment of the present invention. Referring to FIG. 14 and FIG. 17, the mobile device 1400 includes a touch-sensitive display 1401, a motion sensor 1402, a memory 1403, one or more processors 1404 and one or more modules 1405 stored in the memory 1403. The motion sensor 1402 includes at least one of a gravity sensor, a gyroscope or a magnetometer. The modules 1405 are configured for execution by the one or more processors 1404. The one or more modules 1405 include instructions for performing the following tasks: detecting contact with the touch-sensitive display 1401; selecting a widget APP-A21 in a starting page P1 and dragging the widget APP-A21 when the contact starts corresponding to the widget APP-A21; detecting rotation or movement with the motion sensor 1402; transitioning the mobile device 1400 from the starting page P1 to a destination page P2 according to the rotation or the movement; and moving the widget APP-A21 from the starting page P1 to the destination page P2 when the contact terminates at a vacant region 1721 in the destination page P2. In addition, the widget APP-A21 is moved from the starting page P1 to the destination page P2 when the contact is maintained or sustained between the time the contact was started corresponding to the widget APP-A21 and the time the contact terminates in the destination page P2.

To be more specific, at the beginning of the operation of the mobile device, the widgets arranged in the starting page P1 are namely as follow: APP-A11, APP-A12, APP-A13, APP-A21, APP-A22, APP-A23, APP-A31, APP-A32 and APP-A33. In a state 1710, the mobile device 1400 detects contact with the touch-sensitive display 1401. When the contact detected by the mobile device 1400 starts corresponding to the widget APP-A21, the widget APP-A21 in the starting page P1 is selected and dragged. Then, the mobile device 1400 detects rotation or movement with the motion sensor 1402. The rotation or the movement corresponds to a predefined gesture 1711.

It is noted that the method of determining whether the rotation or the movement corresponds to the predefined gesture 1711 is described in patent application Ser. No. 12/967,401, filed on Dec. 14, 2010, which is hereby incorporated by reference herein and made a part of this specification.

In a state 1720, after the selection of the widget APP-A21 in the starting page P1, the mobile device 1400 is transitioned from the starting page P1 to a destination page P2 according to the rotation or the movement. The vacant region 1721 shown in the destination page P2 is configured for placing the widget APP-A21. It is noted that the widgets arranged in the destination page P2 are namely APP-B 11, APP-B 12, APP-B13, APP-B22, APP-B23, APP-B31, APP-B32 and APP-B33, while the widgets arranged in the starting page P1 are namely APP-A11, APP-A12, APP-A13, APP-A22, APP-A23, APP-A31, APP-A32 and APP-A33. The widget APP-A21 is floating, and is neither listed in the starting page P1 nor the destination page P2.

It is noted that the transition between the pages is not limited to that from page P1 to page P2. It may be a transition from page P1 to page P10. In addition, the speed of the transition between the pages may be in proportion to the speed of the rotation or the speed of the movement. For example, when the speed of the rotation is 60 degrees per second, the speed of transition from between the pages may be 1 page per second. And when the speed of the rotation is 300 degrees per second, the speed of transition from between the pages may be 5 pages per second.

Additionally, the contact for the widget APP-A21 detected by the touch-sensitive display 1401 continues to be maintained in the state 1710 and in the state 1720. In the state 1730, the contact terminates at the vacant region 1721 in the destination page P2. The widget APP-A21 is moved from the starting page P1 to the destination page P2. In detail, the widget APP-A21 transitions from the starting page P1 to the destination page P2 when the contact continues to be maintained between the time the contact starts corresponding to the widget APP-A21 and the time the contact terminates in the destination page P2. However, when the contact does not terminate at the vacant region 1721 in the destination page P2, such as, for example, the contact terminates at the widget APP-B23, the widget APP-A21 remains or is kept in the starting page P1.

In the state 1740, the widget APP-A21 is listed in the destination page P2. The widgets arranged in the destination page P2 are namely APP-B11, APP-B12, APP-B13, APP-A21, APP-B22, APP-B23, APP-B31, APP-B32 and APP-B33 while the widgets arranged in the starting page P1 are namely APP-A11, APP-A12, APP-A13, APP-A22, APP-A23, APP-A31, APP-A32 and APP-A33.

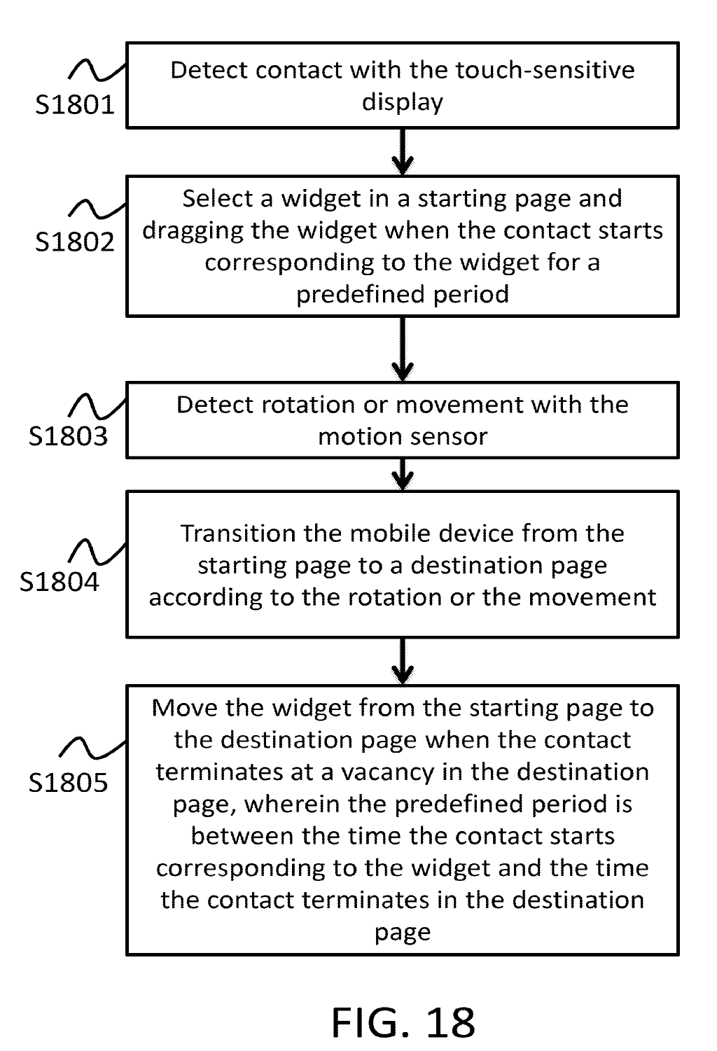

FIG. 18 shows a flow chart of another method of controlling a mobile device configured with a touch-sensitive display and a motion sensor according to the embodiment of the present invention. Please refer to FIG. 18. The method of controlling the mobile device with the touch-sensitive display and a motion sensor of the embodiment includes the following steps: step S1801 of detecting contact with the touch-sensitive display; step S1802 of selecting a widget in a starting page and dragging the widget when the contact starts corresponding to the widget; step S1803 of detecting rotation or movement with the motion sensor; step S1804 of transitioning the mobile device from the starting page to a destination page according to the rotation or the movement; and step S1805 of moving the widget from the starting page to the destination page when the contact terminates in the destination page. In addition, the mobile device includes at least one of a pad, a mobile phone and a notebook.

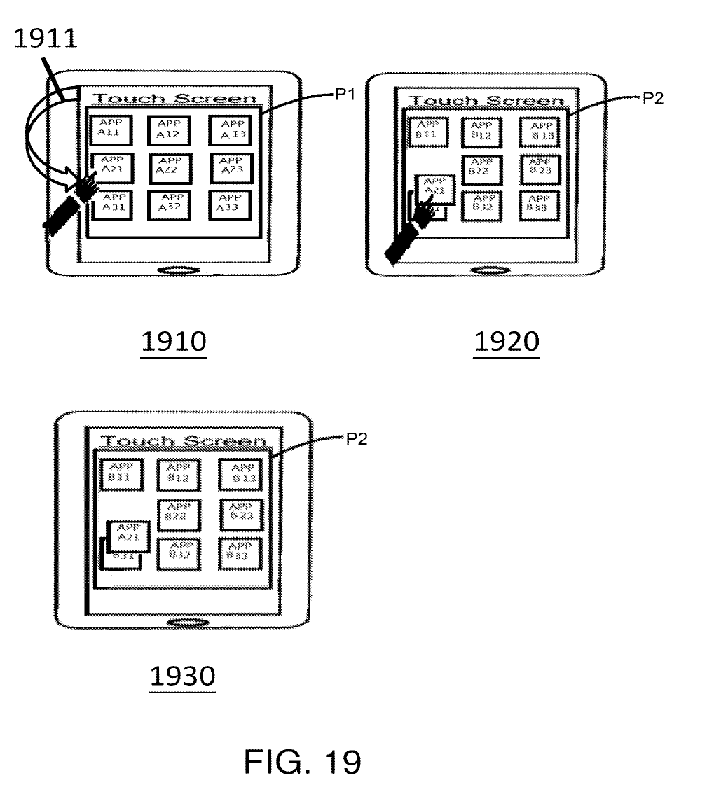

FIG. 19 shows yet another operation of the mobile device according to the embodiment of the present invention. Please refer to FIG. 14 and FIG. 19. To be more specific, at the beginning of the operation of the mobile device, the widgets arranged in the starting page P1 are namely, APP-A11, APP-A12, APP-A13, APP-A21, APP-A22, APP-A23, APP-A31, APP-A32 and APP-A33. In the state 1910, the mobile device 1400 detects contact with the touch-sensitive display 1401. When the contact detected by the mobile device 1400 starts corresponding to the widget APP-A21, the widget APP-A21 in the starting page P1 is selected and dragged. Then, the mobile device 1400 detects rotation or movement with the motion sensor 1402. The rotation or the movement corresponds to a predefined gesture 1911.

It is noted that the method for determining whether the rotation or movement corresponds to the predefined gesture 1911 is described in patent application Ser. No. 12/967,401, filed on Dec. 14, 2010, which is hereby incorporated by reference herein and made a part of this specification.

In the state 1920, after the selection of the widget APP-A21 in the starting page P1, the mobile device 1400 is transitioned from the starting page P1 to a destination page P2 according to the rotation or the movement. The widget APP-A21 is moved from the starting page P1 to the destination page P2. The widget APP-A21 overlaps the widget APP-B31. It is noted that the widgets arranged in the destination page P2 are namely APP-B11, APP-B12, APP-B13, APP-A21, APP-B22, APP-B23, APP-B31, APP-B32 and APP-B33, while the widgets arranged in the starting page P1 are namely APP-A11, APP-A12, APP-A13, APP-A22, APP-A23, APP-A31, APP-A32 and APP-A33.

Additionally, the contact for the widget APP-A21 detected by the touch-sensitive display 1401 continues to be maintained in the state 1910 and in the state 1920. In the state 1920, the contact terminates in the destination page P2. The placement of the widget APP-A21 is not limited to the vacant region in the destination page P2, and may be anywhere in the destination page P2.

In other words, the widget APP-A21 overlapping the widget APP-B31, which refers to the contact not terminating at the vacant region in the destination page P2, may move the widget APP-A21 to the destination page P2. The embodiment shown in FIG. 19 does not require the contact to terminate at the vacant region in the destination page P2. However, in the embodiment shown in FIG. 17, the widget APP-A21 moves to the destination page P2 when the contact terminates at the vacant region in the destination page P2.

In a state 1930, the widget APP-A21 is listed in the destination page P2 and overlaps the widget APP-B31. The widgets arranged in the destination page P2 are namely APP-B11, APP-B12, APP-B13, APP-A21, APP-B22, APP-B23, APP-B31, APP-B32 and APP-B33, while the widgets arranged in the starting page P1 are namely APP-A11, APP-A12, APP-A13, APP-A22, APP-A23, APP-A31, APP-A32 and APP-A33.

It is noted that the starting page and the destination page are not limited to any particular page and are not required to be next to each other. For example, the starting page may be page NO. 3 and the destination page may be page NO. 7.

In the embodiment, a computer program product for use in conjunction configured with a mobile device comprising a touch-sensitive display is provided. The computer program product comprises a computer readable storage medium and an executable computer program mechanism embedded therein. The executable computer program mechanism comprises instructions for performing a plurality of tasks: detecting a contact with the touch-sensitive display while the mobile device is in a first state to determine whether the contact corresponds to a predefined icon; detecting a rotation or a movement with the motion sensor of the mobile device while the mobile device is in the first state to determine whether the rotation or the movement corresponds to a predefined gesture; and transitioning the mobile device to a second state when the contact corresponds to the predefined icon, and the rotation or the movement corresponds to the predefined gesture.

In the embodiment, the computer program product for use in conjunction with the mobile device comprising a touch-sensitive display is provided. The computer program product comprises the computer readable storage medium and the executable computer program mechanism embedded therein. The executable computer program mechanism further comprises instructions for performing the following tasks: detecting contact with the touch-sensitive display; selecting a widget in a starting page and dragging the widget when the contact starts corresponding to the widget; detecting rotation or movement with the motion sensor of the mobile device; transitioning the mobile device from the starting page to a destination page according to the rotation or the movement; and moving the widget from the starting page to the destination page when the contact terminates in the destination page.

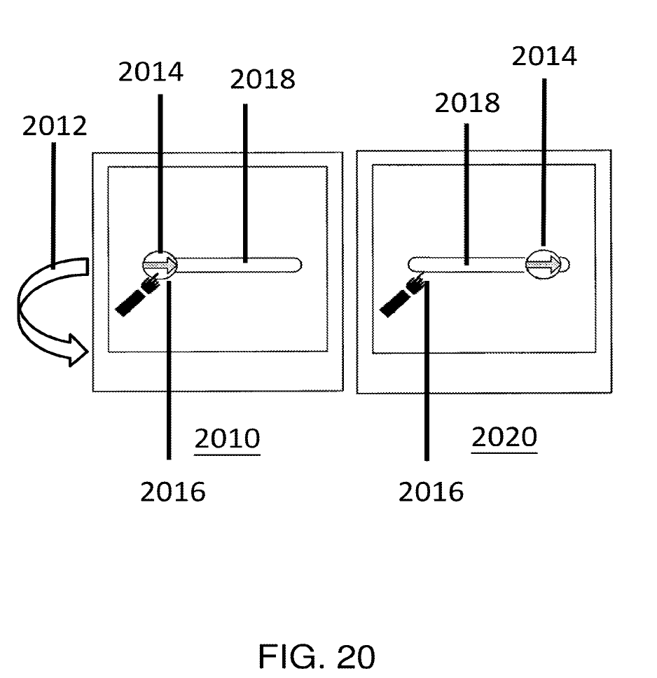

FIG. 20 shows another operation of the mobile device according to the embodiment of the present invention. FIG. 14 shows a block diagram of a mobile device 1400 according to the embodiment of the invention. Referring to FIG. 14 and FIG. 20, the mobile device 1400 includes a touch-sensitive display 1401, a motion sensor 1402, a memory 1403, one or more processors 1404 and one or more modules 1405 stored in the memory 1403. The motion sensor 1402 includes at least one of a gravity sensor, a gyroscope or a magnetometer. The modules 1405 are configured for execution by the one or more processors 1404. The one or more modules 1405 include instructions for performing the following steps: the step of detecting a contact with the touch-sensitive display 1401 while the mobile device 1400 is in the user-interface lock state 2010 to determine whether the contact 2016 corresponds to a predefined icon 2014; the step of detecting a rotation or a movement with the motion sensor 1402 while the mobile device 1400 is in the user-interface lock state 2010 to determine whether the rotation or the movement corresponds to a predefined gesture 2012, wherein the predefined icon 2014 moves along the bar 2018 according to the rotation or the movement; the step of transitioning the mobile device 1400 from the user-interface lock state 2010 to the user-interface lock state 2020 when the contact 2016 is continuously maintained at the beginning of the bar 2018, and the rotation or movement corresponds to the predefined gesture 2012; and the step of transitioning the mobile device 1400 from the user-interface lock state 2020 to a predefined state when the predefined icon 2014 moves to the end of the bar 2018 according to the rotation or the movement, while the contact 2016 remains continuously maintained at the beginning of the bar 2018. In other words, as expressly shown in FIG. 20, the contact 2016 does not slide along together with the movement of the redefined icon 2014 when being moved along the bar 2018.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A system for controlling a display, comprising
an electronic device having a motion sensor module with motion sensor circuitry configured to provide a sensed motion value with respect to each of a plurality of axes, the motion sensor module having an accelerometer with accelerometer circuitry configured to provide an acceleration value of the electronic device, a gyroscope with gyroscope circuitry configured to provide an angular velocity of the electronic device, and a magnetometer with magnetometer circuitry configured to provide a magnetic field value of the electronic device;
at least one processor having processing circuitry configured to:
estimate motion of the electronic device to provide an estimated yaw and an estimated pitch, respectively, based on the angular velocity sensed by the gyroscope;
determine a control movement user input of the electronic device if:
a sum of the acceleration value on each of the plurality of axes corresponds to a force threshold; and
both the estimated yaw and the estimated pitch do not correspond to a rotation threshold;
determine a control rotation user input of the electronic device based on a difference between magnetic parameters, including measured magnetic field values, and angular speed parameters, including estimated magnetic field values estimated based on angular speed values;
adjust information based on at least one of the control movement or the control rotation; and
provide media content configured to display based on the adjusted information.

2. The system of claim 1, wherein, in determining the control rotation user input, if the difference between the magnetic parameters and the angular speed parameters do not correspond to an interference threshold, the at least one processor is configured to determine the control rotation user input based on the magnetic field value.

3. The system of claim 2, wherein, in determining the control rotation user input, if the difference between the magnetic parameters and the angular speed parameters correspond to the interference threshold, the at least one processor is configured to determine the control rotation user input based on the angular speed values.

4. The system of claim 1, wherein the media content is configured to be displayed as map information.

5. The system of claim 1, wherein the media content is configured to be displayed as a street view.

6. The system of claim 5, wherein the street view comprises a 360 degree panoramic image.

7. The system of claim 1, wherein, in estimating motion of the electronic device, the at least one processor is configured to determine a moving direction of the electronic device.

8. The system of claim 7, wherein the at least one processor is configured to determine the moving direction by comparing the acceleration value on each of the plurality of axes.

9. A method for controlling an electronic device having a motion sensor module with motion sensor circuitry configured to provide a sensed motion value with respect to each of a plurality of axes, the motion sensor module having an accelerometer with accelerometer circuitry configured to provide an acceleration value of the electronic device, a gyroscope with gyroscope circuitry configured to provide an angular velocity of the electronic device, a magnetometer with magnetometer circuitry configured to provide a magnetic field value of the electronic device, and at least one processor having processing circuitry, the method comprising:
using the at least one processor to:
estimate motion of the electronic device to provide an estimated yaw and an estimated pitch, respectively, based on the angular velocity sensed by the gyroscope;
determine a control movement user input of the electronic device if:
a sum of the acceleration value on each of the plurality of axes corresponds to a force threshold; and
both the estimated yaw and the estimated pitch do not correspond to a rotation threshold;
determine a control rotation user input of the electronic device based on a difference between magnetic parameters, including measured magnetic field values, and angular speed parameters, including estimated magnetic field values estimated based on angular speed values;
adjust information based on at least one of the control movement or the control rotation; and
provide media content configured to display based on the adjusted information.

10. The method of claim 9, wherein, in determining the control rotation user input, if the difference between the magnetic parameters and the angular speed parameters do not correspond to an interference threshold, the control rotation user input is determined based on the magnetic field value.

11. The method of claim 10, wherein, in determining the control rotation user input, if the difference between the magnetic parameters and the angular speed parameters correspond to the interference threshold, the control rotation user input is determined based on the angular speed values.

12. The method of claim 9, wherein the media content is configured to be displayed as map information.

13. The method of claim 9, wherein the media content is configured to be displayed as a street view.

14. The method of claim 13, wherein the street view comprises a 360 degree panoramic image.

15. The method of claim 9, wherein, in estimating motion of the electronic device, a moving direction of the electronic device is determined.

16. The method of claim 15, wherein the moving direction is determined by comparing the acceleration value on each of the plurality of axes.
